(19) United States
(12) Patent Application Publication
(10) Pub. No.: US 2013/0106169 A1
(43) Pub. Date: May 2, 2013

(54) WHEEL STRUCTURE FOR SIMULATING BIG-RIG WHEEL OF BIG-RIG SEMI TRUCK

(71) Applicant: Mike Chu, Rancho Cucamonga, CA (US)

(72) Inventor: Mike Chu, Rancho Cucamonga, CA (US)

(73) Assignee: Primax Wheel Corp., Rancho Cucamonga, CA (US)

(21) Appl. No.: 13/414,318

(22) Filed: Mar. 7, 2012

Related U.S. Application Data
(60) Provisional application No. 61/553,130, filed on Oct. 28, 2011.

(51) Int. Cl. B60B 27/00

(52) U.S. Cl. 301/108.1

(57) ABSTRACT

A wheel structure for simulating a big-rig wheel of a big-rig semi truck is provided, and the wheel structure has a disc section which is formed with a central hole, a first annular region, and a second annular region in turn, the first annular region is provided with installation holes to install functional bolts and functional nuts of a hub plate of a transmission axle of an automobile, and the second annular region is provided with simulated bolt-and-nut elements. Furthermore, the central hole and the first annular region are covered by a decorative cap. Thus, the wheel structure can be directly installed on the hub plate of the automobile (such as a regular pick-up truck or SUV), while only one set of functional bolts and functional nuts is needed to install the wheel structure on the hub plate of the transmission axle.

### CROSS REFERENCE TO RELATED APPLICATIONS

This application claims the benefit of the filing date of U.S. provisional patent application Ser. No. 61/553,130, filed on Oct. 28, 2011, the disclosure of which is incorporated herein by reference.

### FIELD OF THE INVENTION

The present invention relates to a wheel structure of a regular pick-up truck or a sport utility vehicle (SUV), and more particularly to a wheel structure for simulating a big-rig wheel of a big-rig semi truck.

### BACKGROUND OF THE INVENTION

In recent years, people pay more and more attentions to outdoor activities, and thus there is a trend for people to buy automobiles suitable for outdoor activities, such as regular pick-up trucks or sport utility vehicles (SUVs), for enjoying outdoor activities more conveniently. Furthermore, the regular pick-up trucks or SUVs also can provide various functions, such as shipping goods and carrying more passengers, so that more and more people use these regular pick-up trucks or SUVs.

Moreover, owners of the regular pick-up trucks or SUVs also prefer to decorate their regular pick-up trucks or SUVs with various different appearance designs, wherein one type of the appearance designs is to decorate the wheel structure of the regular pick-up trucks or SUVs in order to simulate as a big-rig semi truck, so that the regular pick-up trucks or SUVs can be looked like a huge powerful truck to provide an attractive appearance.

Generally, when a regular pick-up truck or SUV wants to simulate big-rig semi truck, big-rig wheels of the big-rig semi truck must be used to replace original wheels of the regular pick-up truck or SUV. However, screw holes of the big-rig wheel are generally formed and arranged on an annular region on a disc section of the big-rig wheel, but the diameter of this annular region is greater than that of an original annular region of screws holes of the original wheel. Besides, the bore size of the screw holes of the big-rig wheel may be greater than that of the original holes of the original wheel. Thus, the big-rig wheel can not be directly installed on a hub plate of a transmission axle of the regular pick-up truck or SUV. As a result, an adapter plate must be used between the hub plate of the transmission axle and the big-rig wheel and two sets of different bolts and nuts must be used, in order to screw-connect with the hub plate and the big-rig wheel.

However, the use of the adapter plate will increase the cost of wheel replacement, and may cause a loosening risk of installation and a non-coaxial installation risk, so as to lower the transmission efficiency of the transmission axle and even damage the wheels or the transmission axle.

As a result, it is necessary to provide a wheel structure for simulating a big-rig wheel of a big-rig semi truck to solve the problems existing in the conventional technologies, as described above.

### SUMMARY OF THE INVENTION

A primary object of the present invention is to provide a wheel structure for simulating a big-rig wheel of a big-rig semi truck, wherein the wheel structure has a disc section which is formed with a central hole, a first annular region, and a second annular region in turn, the first annular region is provided with a plurality of installation holes to install a plurality of functional bolts and functional nuts of a hub plate of a transmission axle of an automobile, and the second annular region is provided with a plurality of simulated bolt-and-nut elements. Furthermore, the central hole and the first annular region are covered by a decorative cap. Thus, the wheel structure can be directly installed on the hub plate of the automobile (such as a regular pick-up truck or SUV) without using any adapter plate, while only one set of functional bolts and functional nuts is needed to install the wheel structure on the hub plate of the transmission axle. As a result, the installation structure and operation of the wheel structure for simulating a big-rig wheel can be simplified, and the cost of wheel replacement can be lowered.

To achieve the above object, the present invention provides a wheel structure for simulating a big-rig wheel of a big-rig semi truck, which is used to connect with a hub plate of a transmission axle of an automobile and comprises:

a cylindrical wheel rim having a cylindrical inner space;

a disc section mounted in the cylindrical inner space, and formed with a central hole, a first annular region surrounding the central hole, and a second annular region surrounding the first annular region, wherein the first annular region is provided with a plurality of installation holes to install a plurality of functional bolts and functional nuts of the hub plate of the transmission axle, and the second annular region is provided with a plurality of insertion holes;

a plurality of simulated bolt-and-nut elements installed in the insertion holes and partially projected from the second annular region; and

a decorative cap covering the central hole, the first annular region, the functional bolts and the functional nuts.

In one embodiment of the present invention, the second annular region is further formed with a plurality of thread holes, and the decorative cap is formed with a plurality of connection tabs, each of which has a through hole, wherein the connection tabs of the decorative cap are mounted on the second annular region by a plurality of screw elements screw-connecting the through holes of the connection tabs to the thread holes.

In one embodiment of the present invention, an outer diameter of the second annular region is greater than that of the hub plate.

In one embodiment of the present invention, the first annular region and the second annular region are integrally formed on the disc section.

In one embodiment of the present invention, each of the simulated bolt-and-nut elements is a one-piece element having an insertion portion installed in the insertion hole and a protruded portion projected outward from the second annular region.

In one embodiment of the present invention, each of the simulated bolt-and-nut elements comprises a simulated bolt insertion element having one end installed in the insertion hole and a separable nut element screw-connected on the other end of the simulated bolt insertion element projected from the second annular region.

In one embodiment of the present invention, the disc section is further formed with a third annular region surrounding the second annular region and having a plurality of ventilation holes.

In one embodiment of the present invention, the disc section is a recessed disc section axially recessed in the cylindrical inner space.

In one embodiment of the present invention, the disc section is a protruded disc section axially protruded outward from the cylindrical inner space.

In one embodiment of the present invention, the central hole receives a grease cap or a front end of the hub plate of the transmission axle.

In one embodiment of the present invention, the automobile is a regular pick-up truck or a sport utility vehicle (SUV).

To achieve the above object, the present invention provides a wheel structure for simulating a big-rig wheel, which comprises:

a cylindrical wheel rim having a cylindrical inner space;

a disc section mounted in the cylindrical inner space, and formed with a central hole, a first annular region surrounding the central hole, and a second annular region surrounding the first annular region, wherein the first annular region is provided with a plurality of installation holes, and the second annular region is provided with a plurality of insertion holes;

a plurality of simulated bolt-and-nut elements installed in the insertion holes and partially projected from the second annular region; and

a decorative cap covering the central hole and the first annular region.

In one embodiment of the present invention, the second annular region is further formed with a plurality of thread holes, and the decorative cap is formed with a plurality of connection tabs, each of which has a through hole, wherein the connection tabs of the decorative cap are mounted on the second annular region by a plurality of screw elements screw-connecting the through holes of the connection tabs to the thread holes.

In one embodiment of the present invention, the first annular region and the second annular region are integrally formed on the disc section.

In one embodiment of the present invention, each of the simulated bolt-and-nut elements is a one-piece element having an insertion portion installed in the insertion hole and a protruded portion projected outward from the second annular region.

In one embodiment of the present invention, each of the simulated bolt-and-nut elements comprises a simulated bolt insertion element having one end installed in the insertion hole and a separable nut element screw-connected on the other end of the simulated bolt insertion element projected from the second annular region.

In one embodiment of the present invention, the disc section is further formed with a third annular region surrounding the second annular region and having a plurality of ventilation holes.

In one embodiment of the present invention, the disc section is a recessed disc section axially recessed in the cylindrical inner space.

In one embodiment of the present invention, the disc section is a protruded disc section axially protruded outward from the cylindrical inner space.

According to the present invention, a wheel structure for simulating a big rig wheel of a big-rig semi truck is provided, wherein the wheel structure provides an automotive wheel assembly that looks like a big rig/ring wheel of a big-rig semi truck, so that an automobile (such as regular pick-up truck or SUV) installed with the automotive wheel assembly can be simulated as the big-rig semi truck with big rig wheel. The automotive wheel assembly carries out the simulation by adding 8 to 12 set of nuts and bolts at strategic locations around the actual functional bolt circle of the automotive wheel. This wheel design to fit the regular pick-up truck or SUV that looks like the big rig semi truck. The unique part are the 10 simulated nuts and bolts in the middle of the wheel. The nuts and bolts can be 8˜12 pcs.

### DESCRIPTION OF THE DRAWINGS

FIG. 1 is an exploded perspective view of a wheel structure for simulating a big-rig wheel of a big-rig semi truck according to a preferred embodiment of the present invention;

FIG. 2 is an assembled perspective view of the wheel structure for simulating the big-rig wheel according to the preferred embodiment of the present invention; and

FIG. 3 is a schematic installation view of the wheel structure for simulating the big-rig wheel installed on a regular pick-up truck according to the preferred embodiment of the present invention.

### DETAILED DESCRIPTION OF THE PREFERRED EMBODIMENTS

The structure and the technical means adopted by the present invention to achieve the above and other objects can be best understood by referring to the following detailed description of the preferred embodiments and the accompanying drawings. Furthermore, directional terms described by the present invention, such as upper, lower, front, back, left, right, inner, outer, side, longitudinal/vertical, transverse/horizontal, and etc., are only directions by referring to the accompanying drawings, and thus the used directional terms are used to describe and understand the present invention, but the present invention is not limited thereto.

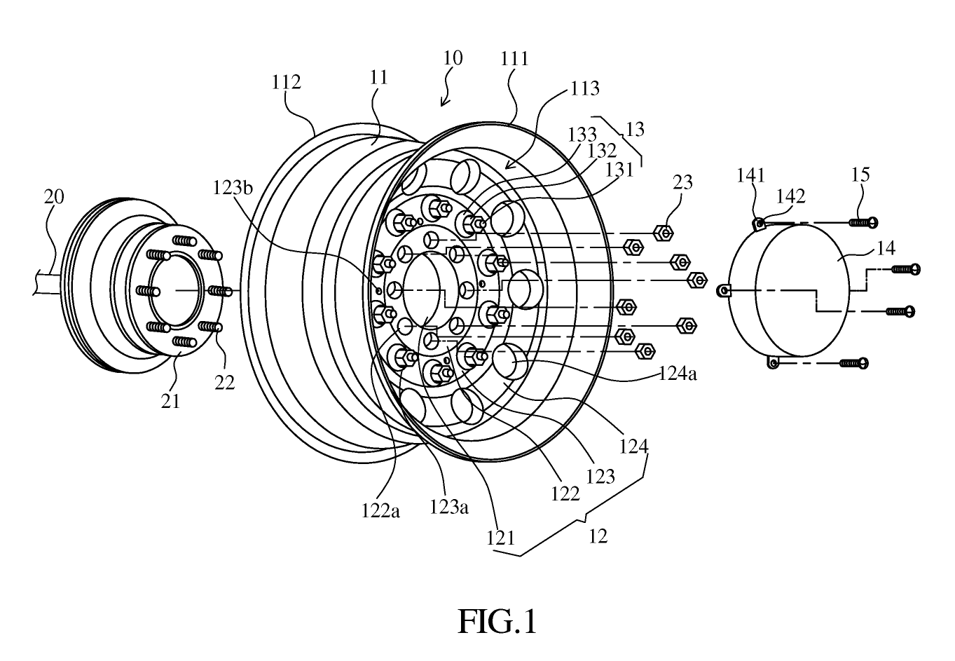

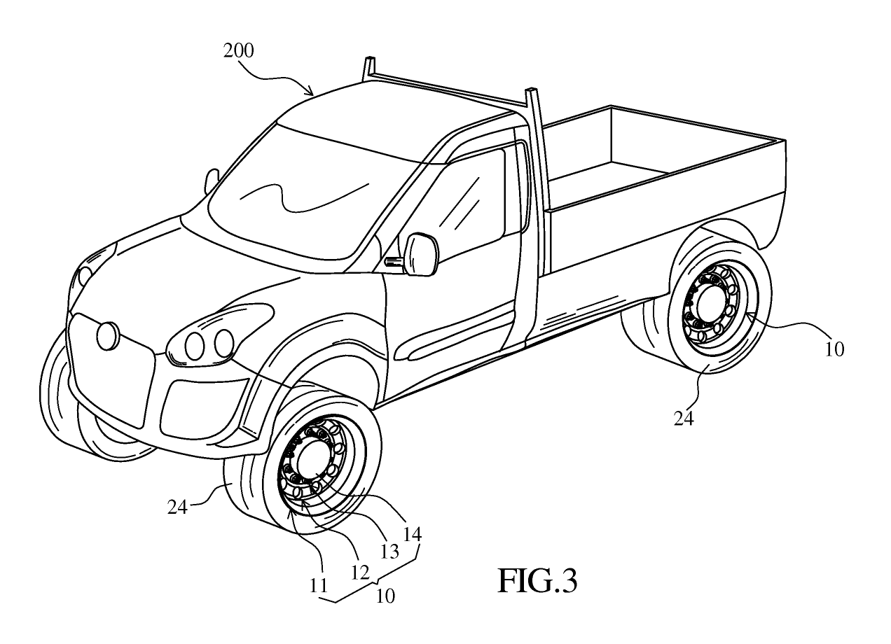

Referring now to FIGS. 1, 2 and 3, a wheel structure for simulating a big-rig wheel of a big-rig semi truck according to a preferred embodiment of the present invention are illustrated. As shown, the wheel structure designated by numeral 10 is used to connect with a hub plate 21 of a transmission axle 20 of an automobile 200 for simulating a big-rig wheel of a big-rig semi truck, wherein the automobile 200 is preferably an automobile suitable for outdoor activities, such as a regular pick-up truck or a sport utility vehicle (SUV), but the automobile 200 called herein is not a big-rig semi truck, i.e. excluding the big-rig semi truck. According to the preferred embodiment, the wheel structure 10 comprises: a cylindrical wheel rim 11, a disc section 12, a plurality of simulated bolt-and-nut elements 13, a decorative cap 14 and a plurality of screw elements 15.

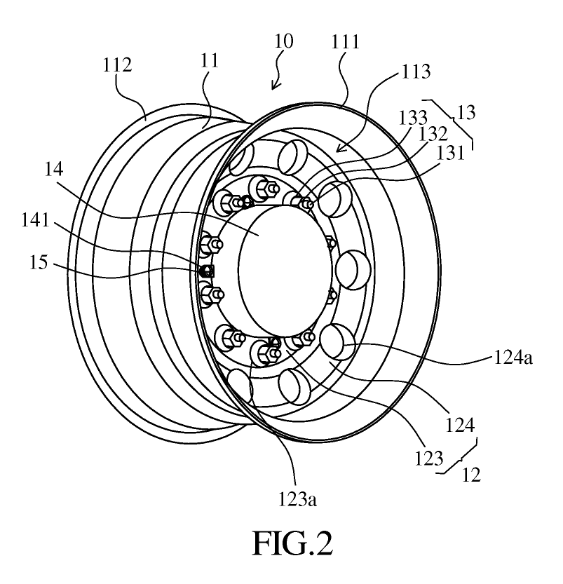

Referring to FIGS. 1 and 2, in the preferred embodiment of the present invention, the cylindrical wheel rim 11 is a hollow cylindrical metal body, and has a first opening 111, a second opening 112 and a cylindrical inner space 113 defined between the first opening 111 and the second opening 112. Furthermore, the disc section 12 is a disc-like metal plate which is mounted in the cylindrical inner space 113 by welding, one-piece casting or other existing technologies. In the embodiment, the disc section 12 can be a recessed disc section axially recessed in the cylindrical inner space 13 along the axial direction of the transmission axle 20. In an alternative embodiment, the disc section 12 also can be a protruded disc section axially protruded outward from the cylindrical inner space 13 to the outer space of the cylindrical wheel rim 11 for providing different wheel designs to be applied to different automobile.

In addition, the disc section 12 is formed with a central hole 121, a first annular region 122, a second annular region 123 and a third annular region 124 from a central portion to a peripheral portion of the disc section 12 in turn. The central hole 121 is a through hole with a relatively larger bore size, and the central hole 121 receives a grease cap or a front end of the hub plate 21 of the transmission axle 20. The first annular region 122 is surrounding the central hole 121 and provided with a plurality of installation holes 122a with a relatively smaller bore size, and the installation holes 122a are used to install a plurality of functional bolts 22 and functional nuts 23 of the hub plate 21 of the transmission axle 20. The number of the installation holes 122a, the functional bolts 22 and the functional nuts 23 are the same, such as 8-12 set, without limitation.

Moreover, the second annular region 123 is surrounding the first annular region 122, wherein the first annular region 122 and the second annular region 123 are integrally formed on the disc section 12 to simplify the entire structure of the wheel structure 10. The second annular region 123 is further provided with a plurality of insertion holes 123a having a bore size smaller than that of the central hole 121 and larger than that of the installation holes 122a. The number of the insertion holes 123a is preferably 8-12 set, but also not limited thereto. The third annular region 124 is surrounding the second annular region 123 and has a plurality of ventilation holes 124a, wherein the number of the ventilation holes 124a is also preferably 8-12 set, but not limited thereto.

Referring still to FIGS. 1 and 2, in the preferred embodiment of the present invention, the plurality of simulated bolt-and-nut elements 13 are installed in the insertion holes 123a and partially projected from the surface of the second annular region 123. In the embodiment, each of the simulated bolt-and-nut elements 13 is a one-piece element which has an insertion portion 133 and a protruded portion, wherein the insertion portion 133 is installed in the insertion hole 123a, and the protruded portion includes a simulated bolt 131 and a simulated nut 132, both of which are projected outward from the surface of the second annular region 123. In an alternative embodiment, each of the simulated bolt-and-nut elements 13 also can comprise a simulated bolt insertion element having one inserted end (i.e. the portion of numeral 133) installed in the insertion hole 123a and a separable nut element (i.e. the portion of numeral 132) screw-connected on the other protruded end (i.e. the portion of numeral 131) of the simulated bolt insertion element projected from the surface of the second annular region 123. Moreover, the simulated bolt-and-nut elements 13 has no function of screw-connection and are only used to simulate the large bolts and nuts of a big-rig wheel. The simulated bolt-and-nut elements 13 can be made of metal material or made of plastic material coated with a metal-like coating for reducing the entire weight of the wheel structure 10.

Referring to FIGS. 1 and 2 again, in the preferred embodiment of the present invention, the decorative cap 14 is a hollow cap made of metal material or made of plastic material coated with a metal-like coating for reducing the entire weight of the wheel structure 10. The decorative cap 14 is used to cover the central hole 121, the first annular region 122, the functional bolts 22 and the functional nuts 23, so that the central hole 121, the first annular region 122, the functional bolts 22 and the functional nuts 23 can be hidden and can not be seen from the outside of the disc section 12 of the wheel structure 2, in order to prevent from affecting the appearance of the wheel structure 10. In details, the second annular region 123 is further formed with a plurality of thread holes 123b, and the decorative cap 14 is formed with a plurality of connection tabs 141, each of which has a through hole 142, wherein the connection tabs 141 of the decorative cap 14 are mounted on the second annular region 123 by the screw elements 15 which is used to screw-connect the through holes 142 of the connection tabs 141 to the thread holes 123b. However, the decorative cap 14 also can be mounted on the second annular region 123 by other means, such as adhesive, engagement, welding and etc.

Referring now to FIGS. 1, 2 and 3, when a user wants to install the wheel structure 10 with a tire 24 on the hub plate 21 of the transmission axle 20 of the automobile 200 (e.g. a regular pick-up truck or a SUV), the second opening 112 of the cylindrical wheel rim 11 firstly faces the hub plate 21, and the cylindrical wheel rim 11 is moved toward the hub plate 21, until an inner surface of the disc section 12 facing the hub plate 21 is in contact with the hub plate 21. At this time, the functional bolts 22 of the hub plate 21 pass through the installation holes 122a of the first annular region 122, while the functional nuts 23 are screw-connected with the functional bolts 22, in order to fix the wheel structure 10 on the hub plate 21.

After this, the decorative cap 14 is used to cover the central hole 121, the first annular region 122, the functional bolts 22 and the functional nuts 23, and then the screw elements 15 is used to screw-connect the through holes 142 of the connection tabs 141 to the thread holes 123b. Thus, the decorative cap 14 are mounted on the second annular region 123. It should be noted that an outer diameter of the second annular region 123 is designed to be greater than that of the hub plate 21. In other words, the insertion holes 123a and the simulated bolt-and-nut elements 13 surround the installation holes 122a, the functional bolts 22 and the functional nuts 23. Thus, the wheel structure 10 will be looked like a big-rig wheel having relatively larger bolts and nuts, a relatively larger annular region of the bolts and nuts, and a relatively larger tire 24. As a result, the wheel structure 10 can simulate as a big-rig wheel to cause that the automobile 200 can be looked like a big-rig semi truck.

As described above, according to the present invention, the wheel structure 10 can be directly installed on the hub plate 21 of the transmission axle 20 of the automobile 200 (such as a regular pick-up truck or SUV) without using any adapter plate, while only one set of functional bolts 22 and functional nuts 23 is needed to install the wheel structure 10 on the hub plate 21 of the transmission axle 20. Furthermore, the first annular region 122 and the second annular region 123 are integrally formed on the disc section 12. As a result, the installation structure and operation of the wheel structure 10 for simulating a big-rig wheel can be simplified, and the cost of wheel replacement can be lowered.

The present invention has been described with a preferred embodiment thereof and it is understood that many changes and modifications to the described embodiment can be carried out without departing from the scope and the spirit of the invention that is intended to be limited only by the appended claims.

What is claimed is:

1. A wheel structure for simulating a big-rig wheel of a big-rig semi truck, the wheel structure being connected with a hub plate of a transmission axle of an automobile, and the wheel structure comprising:
a cylindrical wheel rim having a cylindrical inner space;
a disc section mounted in the cylindrical inner space, and formed with a central hole, a first annular region surrounding the central hole, and a second annular region surrounding the first annular region, wherein the first annular region is provided with a plurality of installation holes to install a plurality of functional bolts and functional nuts of the hub plate of the transmission axle, and the second annular region is provided with a plurality of insertion holes;
a plurality of simulated bolt-and-nut elements installed in the insertion holes and partially projected from the second annular region; and
a decorative cap covering the central hole, the first annular region, the functional bolts and the functional nuts.

2. The wheel structure according to claim 1, wherein the second annular region is further formed with a plurality of thread holes, and the decorative cap is formed with a plurality of connection tabs, each of which has a through hole, wherein the connection tabs of the decorative cap are mounted on the second annular region by a plurality of screw elements screw-connecting the through holes of the connection tabs to the thread holes.

3. The wheel structure according to claim 1, wherein an outer diameter of the second annular region is greater than that of the hub plate.

4. The wheel structure according to claim 1, wherein the first annular region and the second annular region are integrally formed on the disc section.

5. The wheel structure according to claim 1, wherein each of the simulated bolt-and-nut elements is a one-piece element having an insertion portion installed in the insertion hole and a protruded portion projected outward from the second annular region.

6. The wheel structure according to claim 1, wherein each of the simulated bolt-and-nut elements comprises a simulated bolt insertion element having one end installed in the insertion hole and a separable nut element screw-connected on the other end of the simulated bolt insertion element projected from the second annular region.

7. The wheel structure according to claim 1, wherein the disc section is further formed with a third annular region surrounding the second annular region and having a plurality of ventilation holes.

8. The wheel structure according to claim 1, wherein the disc section is a recessed disc section axially recessed in the cylindrical inner space.

9. The wheel structure according to claim 1, wherein the disc section is a protruded disc section axially protruded outward from the cylindrical inner space.

10. The wheel structure according to claim 1, wherein the central hole receives a grease cap or a front end of the hub plate of the transmission axle.

11. The wheel structure according to claim 1, wherein the automobile is a regular pick-up truck or a sport utility vehicle (SUV).

12. A wheel structure for simulating a big-rig wheel, comprising:
a cylindrical wheel rim having a cylindrical inner space;
a disc section mounted in the cylindrical inner space, and formed with a central hole, a first annular region surrounding the central hole, and a second annular region surrounding the first annular region, wherein the first annular region is provided with a plurality of installation holes, and the second annular region is provided with a plurality of insertion holes;
a plurality of simulated bolt-and-nut elements installed in the insertion holes and partially projected from the second annular region; and
a decorative cap covering the central hole and the first annular region.

13. The wheel structure according to claim 12, wherein the second annular region is further formed with a plurality of thread holes, and the decorative cap is formed with a plurality of connection tabs, each of which has a through hole, wherein the connection tabs of the decorative cap are mounted on the second annular region by a plurality of screw elements screw-connecting the through holes of the connection tabs to the thread holes.

14. The wheel structure according to claim 12, wherein the first annular region and the second annular region are integrally formed on the disc section.

15. The wheel structure according to claim 12, wherein each of the simulated bolt-and-nut elements is a one-piece element having an insertion portion installed in the insertion hole and a protruded portion projected outward from the second annular region.

16. The wheel structure according to claim 12, wherein each of the simulated bolt-and-nut elements comprises a simulated bolt insertion element having one end installed in the insertion hole and a separable nut element screw-connected on the other end of the simulated bolt insertion element projected from the second annular region.

17. The wheel structure according to claim 12, wherein the disc section is further formed with a third annular region surrounding the second annular region and having a plurality of ventilation holes.

18. The wheel structure according to claim 12, wherein the disc section is a recessed disc section axially recessed in the cylindrical inner space.

19. The wheel structure according to claim 12, wherein the disc section is a protruded disc section axially protruded outward from the cylindrical inner space.
